(19) United States
(12) Patent Application Publication
(10) Pub. No.: US 2025/0105412 A1
(43) Pub. Date: Mar. 27, 2025

(54) SECONDARY BATTERY AND BATTERY ASSEMBLY

(71) Applicant: Prime Planet Energy & Solutions, Inc., Tokyo (JP)

(72) Inventor: Nobuyoshi TACHIBANA, Kobe-shi (JP)

(21) Appl. No.: 18/820,258

(22) Filed: Aug. 30, 2024

(30) Foreign Application Priority Data
Sep. 27, 2023 (JP) 2023-165255

(51) Int. Cl. H01M 50/186; H01M 50/103; H01M 50/124; H01M 50/131; H01M 50/184; H01M 50/342

(52) U.S. Cl. CPC H01M 50/186; H01M 50/103; H01M 50/124; H01M 50/131; H01M 50/184; H01M 50/3425

(57) ABSTRACT

A secondary battery includes an electrode assembly and a case accommodating the electrode assembly. The case includes a case body having one end portion provided with a first opening and another end portion provided with a second opening, a first sealing plate sealing the first opening, and a second sealing plate sealing the second opening. The case body includes a pair of first wall portions facing each other, and a pair of second wall portions facing each other. An area of the first wall portion is larger than an area of the second wall portion. At least one of the first wall portions includes a thin portion that, when pressure in the case becomes equal to or exceeds a predetermined value, ruptures and causes gas in the case to be discharged out of the case.

### CROSS REFERENCE TO RELATED APPLICATIONS

This nonprovisional application is based on Japanese Patent Application No. 2023-165255 filed on Sep. 27, 2023 with the Japan Patent Office, the entire contents of which are hereby incorporated by reference.

### BACKGROUND OF THE INVENTION

### Field of the Invention

The present technology relates to a secondary battery and a battery assembly.

### Description of the Background Art

Examples of related art documents that disclose a configuration of a secondary battery include Japanese Patent Laying-Open No. 2005-038773, Japanese Patent Laying-Open No. 2001-126693, Japanese Patent Laying-Open No. 2001-307707, Japanese Patent Laying-Open No. 2001-345083, and Japanese Patent Laying-Open No. 2001-266812. An explosion-proof valve configured of a thin portion or the like in each of these secondary batteries is provided in a side surface being orthogonal to a terminal surface and having a larger area.

### SUMMARY OF THE INVENTION

A secondary battery for consumer use such as one in a smartphone is installed in the device as a single body. However, for use in a vehicle or use as storage of electricity, secondary batteries are employed in a state of being arranged side by side so as to obtain output and capacitance.

When the secondary batteries are used in the state of being arranged side by side, it is required for an explosion-proof valve to function stably even if the explosion-proof valve is provided in a surface being orthogonal to a terminal surface and having a larger area.

The present technology has been devised in order to meet the above-described demand and is aimed at providing a secondary battery and a battery assembly that are highly reliable and can sufficiently ensure a cleavage function of an explosion-proof valve constituted of a vulnerable portion.

The present technology provides the following secondary battery.
[1] A secondary battery comprising: an electrode assembly including a first electrode, and a second electrode having a polarity different from a polarity of the first electrode; and a case accommodating the electrode assembly; wherein the case includes a case body having one end portion provided with a first opening and another end portion provided with a second opening, a first sealing plate sealing the first opening, and a second sealing plate sealing the second opening, the case body includes a pair of first wall portions facing each other, and a pair of second wall portions facing each other, an area of the first wall portion is larger than an area of the second wall portion, and at least one of the first wall portions includes a thin portion that, when pressure in the case becomes equal to or exceeds a predetermined value, ruptures and causes gas in the case to be discharged out of the case.
[2] The secondary battery according to [1], wherein the thin portion is provided both near an end portion of one of the first wall portions on a first sealing plate side and near an end portion of the other of the first wall portions on a second sealing plate side.
[3] The secondary battery according to [1] or [2], wherein the thin portion is provided both near an end portion of one of the first wall portions on a first sealing plate side and near an end portion of the one of the first wall portions on a second sealing plate side.
[4] The secondary battery according to any one of [1] to [3], wherein the thin portion is formed in at least one of a region facing a portion between an end portion of a body portion of the electrode assembly on a first sealing plate side and the first sealing plate, and a region facing a portion between an end portion of the body portion of the electrode assembly on a second sealing plate side and the second sealing plate.
[5] The secondary battery according to any one of [1] to [4], wherein the electrode assembly is a wound electrode assembly having a flat shape and includes a bent portion having a pair of bending outer surfaces, and the thin portion is formed in a position where the thin portion faces the bent portion.
[6] The secondary battery according to any one of [1] to [5], wherein the thin portion includes a first linear portion, and a plurality of second linear portions intersecting the first linear portion.

The present technology provides the following battery assembly.
[7] A battery assembly comprising a plurality of secondary batteries, wherein the secondary battery includes an electrode assembly including a first electrode, and a second electrode having a polarity different from a polarity of the first electrode, and a case accommodating the electrode assembly, the case includes a case body having one end portion provided with a first opening and another end portion provided with a second opening, a first sealing plate sealing the first opening, and a second sealing plate sealing the second opening, the case body includes a pair of first wall portions facing each other, and a pair of second wall portions facing each other, an area of the first wall portion is larger than an area of the second wall portion, at least one of the first wall portions includes a thin portion that, when pressure in the case becomes equal to or exceeds a predetermined value, ruptures and causes gas in the case to be discharged out of the case, and among the secondary batteries, an inter-cell separator is arranged between the first wall portions that adjoin each other and are arranged so as to face each other.
[8] The battery assembly according to [7], wherein at least part of the thin portion is arranged in a position where the at least part of the thin portion does not overlap the inter-cell separator when viewed in a direction orthogonal to the first wall portion.
[9] The battery assembly according to [7] or [8], wherein the inter-cell separator includes a first region having a thickness smaller than a thickness of a remaining portion, and at least part of the thin portion faces the first region.
[10] The battery assembly according to [9], wherein the first region is a tapering portion.
[11] The battery assembly according to any one of [7] to [10], wherein the inter-cell separator includes an elastic layer, and at least part of the thin portion faces the elastic layer.
[12] The battery assembly according to any one of [7] to [11], wherein the inter-cell separator includes an elastic layer and a heat-resistant layer, and a facing area of the heat-resistant layer and the thin portion is larger than a facing area of the elastic layer and the thin portion.

The foregoing and other objects, features, aspects and advantages of the present invention will become apparent from the following detailed description of the present invention, which will be understood in conjunction with the accompanying drawings.

### BRIEF DESCRIPTION OF THE DRAWINGS

FIG. 1 is a perspective view illustrating a configuration of a secondary battery according to an embodiment of the present technology.

FIG. 2 is a front view illustrating the configuration of the secondary battery according to the embodiment of the present technology.

FIG. 3 is a diagram illustrating a state in which the secondary battery depicted in FIG. 1 is viewed in the direction of arrow III.

FIG. 4 is a diagram illustrating a state in which the secondary battery depicted in FIG. 1 is viewed in the direction of arrow IV.

FIG. 5 is a diagram illustrating a state in which the secondary battery depicted in FIG. 1 is viewed in the direction of arrow V.

FIG. 6 is a front cross-sectional view of the secondary battery depicted in FIG. 1.

FIG. 7 is a cross-sectional view illustrating a vulnerable portion (a thin portion) that constitutes a gas-discharge valve.

FIG. 8 is a cross-sectional view illustrating the vulnerable portion (the thin portion) that constitutes the gas-discharge valve and has another configuration.

FIG. 9 is a diagram illustrating another arrangement of the gas-discharge valve.

FIG. 10 is a diagram illustrating still another arrangement of the gas-discharge valve.

FIG. 11 is a diagram illustrating yet another arrangement of the gas-discharge valve.

FIG. 12 is a diagram illustrating a variation of the gas-discharge valve.

FIG. 13 is a diagram illustrating another variation of the gas-discharge valve.

FIG. 14 is a schematic diagram illustrating a configuration of a battery assembly.

FIG. 15 is a schematic diagram of the battery assembly in which only an elastic layer is provided between the secondary batteries arranged side by side.

FIG. 16 is a schematic diagram illustrating a cleavage state of a first gas-discharge valve at the time when gas is discharged in the battery assembly depicted in FIG. 15.

FIG. 17 is a schematic diagram of the battery assembly in which only a heat-resistant layer is provided between the secondary batteries arranged side by side.

FIG. 18 is a schematic diagram illustrating a cleavage state of the first gas-discharge valve at the time when gas is discharged in the battery assembly depicted in FIG. 17.

### DESCRIPTION OF THE PREFERRED EMBODIMENTS

Embodiments of the present technology are described below. The same or corresponding portions are denoted by the same reference characters, and may not be described repeatedly.

In the embodiments described below, when reference is made to a number, an amount, and the like, the scope of the present technology is not necessarily limited to the number, the amount, and the like unless otherwise stated particularly. Further, in the embodiments described below, each component is not necessarily essential to the present technology unless otherwise stated particularly. Further, the present technology is not limited to one that necessarily exhibits all the functions and effects mentioned in the present embodiment.

In the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms tolerate manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (e.g. by reversing the entire mechanism upside down).

In the present specification, the term “secondary battery” is not limited to a lithium ion battery, and may include other secondary batteries such as a nickel-metal hydride battery and a sodium ion battery. In the present specification, the term “electrode” may collectively represent a positive electrode and a negative electrode.

In the drawings, a direction along a winding axis of an electrode assembly included in the secondary battery is an X direction as a first direction, a direction that is orthogonal to the first direction and, when viewed in the first direction, corresponds to the short-side direction of the electrode assembly is a Y direction as a second direction, and a direction that is orthogonal to the first direction and, when viewed in the first direction, corresponds to the long-side direction of the electrode assembly is a Z direction as a third direction. Further, in order to facilitate understanding of the invention, the size of each constituent element in the drawings may be changed from the actual size thereof when it is depicted.

Herein, the first direction (the X direction) may be referred to as the “width direction” of the secondary battery or the case body, the second direction (the Y direction) may similarly be referred to as the “thickness direction” of the secondary battery or the case body, and the third direction (the Z direction) may similarly be referred to as the “height direction” of the secondary battery or the case body.

### (Overall Configuration of Secondary Battery)

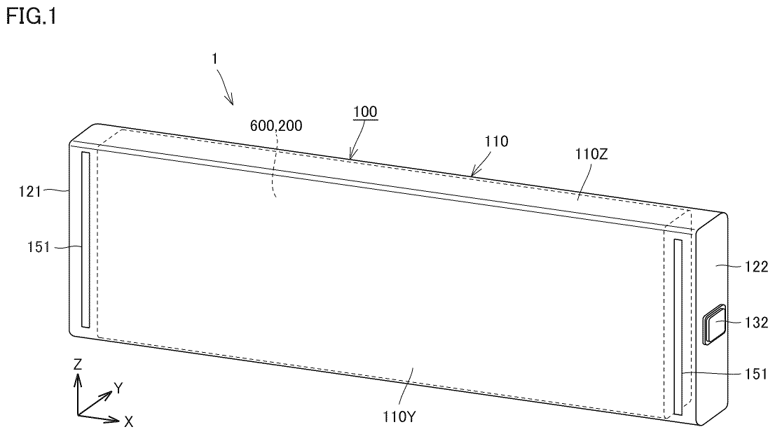

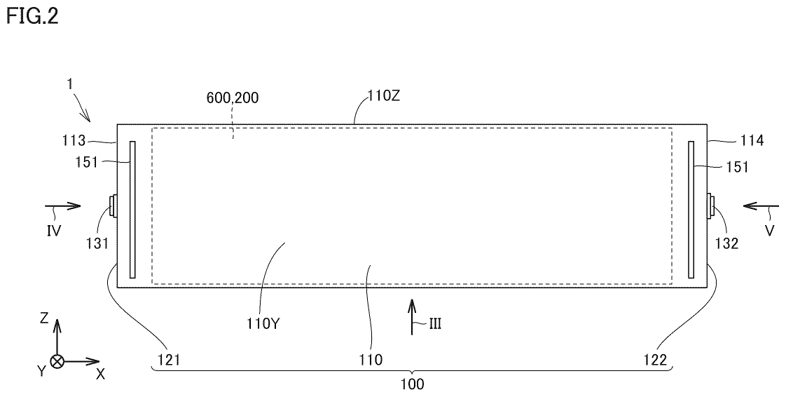

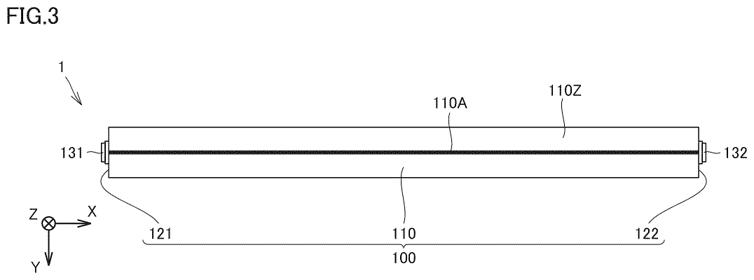

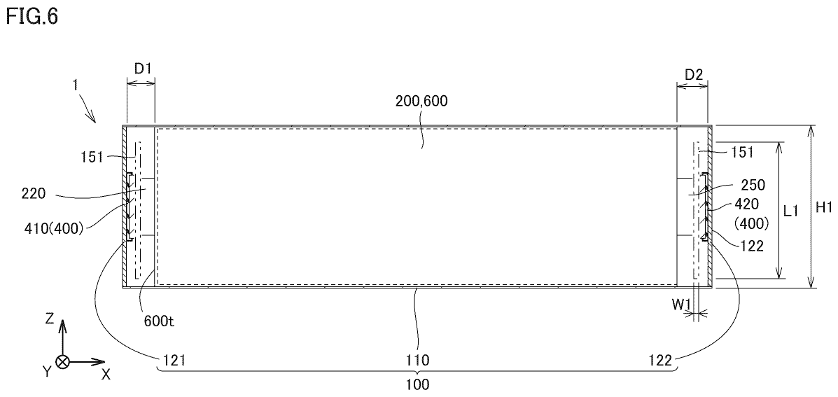

Referring to FIGS. 1 to 6, an overall configuration of the secondary battery is described. FIG. 1 is a perspective view of secondary battery 1, FIG. 2 is a front view thereof, and FIGS. 3 to 5 are diagrams illustrating respective states in which secondary battery 1 depicted in FIG. 1 is viewed in the direction of arrow III, the direction of arrow IV, and the direction of arrow V. FIG. 6 is a front cross-sectional view of secondary battery 1 depicted in FIG. 1.

Secondary battery 1 can be mounted on a vehicle such as a battery electric vehicle (BEV), a plug-in hybrid electric vehicle (PHEV), and a hybrid electric vehicle (HEV). The use of secondary battery 1 is not limited to the use in a vehicle.

As illustrated in FIGS. 1 to 5, secondary battery 1 includes a case 100, an electrode assembly 200, and a current collector 400. Case 100 includes a case body 110, a first sealing plate 121, and a second sealing plate 122.

When a battery assembly including secondary battery 1 is constructed, a plurality of secondary batteries 1 are arranged side by side in the thickness direction thereof. The secondary batteries 1 arranged side by side may constitute a battery module by being restrained in the arrangement direction (the Y direction) by a restraint member or may be directly supported as a battery assembly on a side surface of the case of a battery pack.

Case body 110 is formed of a member having a tubular shape, which is preferably a rectangular tubular shape. Thus, secondary battery 1 with a rectangular shape is obtained. Case body 110 is made of metal. Specifically, case body 110 is composed of aluminum, an aluminum alloy, iron, an iron alloy, or the like.

As illustrated in FIGS. 1 and 2, first sealing plate 121 and second sealing plate 122 are provided on respective end portions of case body 110. Case body 110 can be formed into the rectangular tubular shape by, for example, causing end sides of a plate-shaped member having been bent to abut on each other (see a joint portion 110A illustrated in FIG. 3) and joining the end sides together (e.g. by laser welding). A corner portion of the “rectangular tubular shape” may have a round shape. Joint portion 110A in the present embodiment extends across an outer peripheral surface portion of case body 110 in the first direction (the X direction).

In the present embodiment, case body 110 is formed so that the dimension in the width direction of secondary battery 1 (the X direction) is longer than the respective dimensions in the thickness direction of secondary battery 1 (the Y direction) and the height direction of secondary battery 1 (the Z direction). The dimension (width) of case body 110 in the X direction is preferably about 30 cm or more. Thus, secondary battery 1 that is relatively large in size (has a high capacity) can be constructed. The dimension (height) of case body 110 in the Z direction is preferably about 20 cm or less, is more preferably about 15 cm or less, and is still more preferably about 10 cm or less. Thus, secondary battery 1 that is relatively low in height (has a low height) can be constructed and, for example, the capability of being mounted in a vehicle is enhanced.

Case body 110 includes a pair of first side surface portions 110Y and a pair of second side surface portions 110Z. The pair of first side surface portions 110Y constitute part of the side surface of case 100. The pair of second side surface portions 110Z constitute a bottom surface portion and an upper surface portion of case 100. The pair of first side surface portions 110Y and the pair of second side surface portions 110Z are provided so as to intersect. The pair of first side surface portions 110Y and the pair of second side surface portions 110Z are connected to first sealing plate 121 and second sealing plate 122 in their respective end portions. The area of each of the pair of first side surface portions 110Y is desirably larger than the area of each of the pair of second side surface portions 110Z. The area of each of the pair of first side surface portions 110Y is desirably larger than the area of each of first sealing plate 121 and second sealing plate 122.

As illustrated in FIG. 4, a first opening 113 is provided in a first end portion of case body 110 in the first direction (the X direction). First opening 113 is sealed with first sealing plate 121. Each of first opening 113 and first sealing plate 121 has a substantially rectangular shape in which the Y direction corresponds to the short-side direction and the Z direction corresponds to the long-side direction.

A negative electrode terminal 131 (a first electrode terminal) and an electrolyte injection hole 124 are provided on first sealing plate 121. A configuration in which first sealing plate 121 is provided with a gas-discharge valve can also be adopted. However, in the present embodiment, no gas-discharge valve is provided on first sealing plate 121 since first side surface portion 110Y is provided with a gas-discharge valve constituted of a vulnerable portion as described later. The positions of negative electrode terminal 131 and electrolyte injection hole 124 can be changed as necessary.

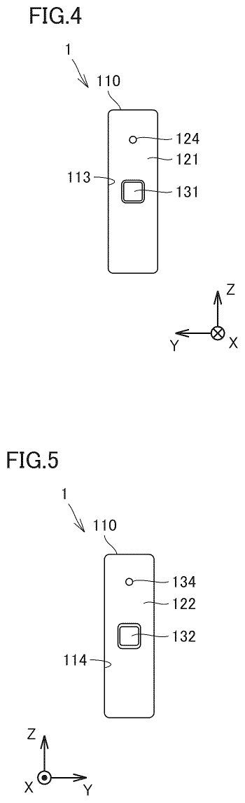

As illustrated in FIG. 5, a second opening 114 is provided in a second end portion of case body 110, which is opposite the first end portion in the first direction (the X direction). Second opening 114 is sealed with second sealing plate 122. Each of second opening 114 and second sealing plate 122 has a substantially rectangular shape in which the Y direction corresponds to the short-side direction and the Z direction corresponds to the long-side direction.

A positive electrode terminal 132 (a second electrode terminal) and an electrolyte injection hole 134 are provided on second sealing plate 122. A configuration in which second sealing plate 122 is provided with a gas-discharge valve can also be adopted. However, in the present embodiment, no gas-discharge valve is provided on second sealing plate 122 since first side surface portion 110Y is provided with a gas-discharge valve constituted of a vulnerable portion as described later. The positions of positive electrode terminal 132 and electrolyte injection hole 134 can be changed as necessary.

First sealing plate 121 and second sealing plate 122 are made of metal. Specifically, first sealing plate 121 and second sealing plate 122 are each composed of aluminum, an aluminum alloy, iron, an iron alloy, or the like.

In the present embodiment, the thickness of each of first sealing plate 121 and second sealing plate 122 is preferably set so as to be greater than the thickness (plate thickness) of case body 110.

Negative electrode terminal 131 is electrically connected to the negative electrode of electrode assembly 200. Negative electrode terminal 131 is attached to first sealing plate 121, that is, case 100.

Positive electrode terminal 132 is electrically connected to the positive electrode of electrode assembly 200. Positive electrode terminal 132 is attached to second sealing plate 122, that is, case 100.

Negative electrode terminal 131 is composed of a conductive material (more specifically, metal) and can be composed of, for example, copper, a copper alloy, or the like. On an outer surface portion of negative electrode terminal 131, a part or layer composed of aluminum or an aluminum alloy may be provided.

Positive electrode terminal 132 is composed of a conductive material (more specifically, metal) and can be composed of, for example, aluminum, an aluminum alloy, or the like.

Electrolyte injection holes 124 and 134 are each sealed with a sealing member (not illustrated). As the sealing member, for example, a blind rivet or another metal member can be used.

Electrode assembly 200 is an electrode assembly having a flat shape, which includes a positive electrode plate and a negative electrode plate. Electrode assembly 200 is a wound type electrode assembly in which a belt-shaped positive electrode plate and a belt-shaped negative electrode plate are wound together with interposition of a belt-shaped separator, not illustrated. Herein, however, the “electrode assembly” is not limited to the wound type electrode assembly but may be a stack type electrode assembly in which a plurality of positive electrode plates and a plurality of negative electrode plates are alternately stacked. The belt-shaped separator may be composed of, for example, a polyolefin-based microporous film. The electrode assembly may include a plurality of positive electrode plates and a plurality of negative electrode plates, respective positive electrode tabs provided on the positive electrode plates may constitute a positive electrode tab by being stacked, and respective negative electrode tabs provided on the negative electrode plates may constitute a negative electrode tab by being stacked.

As illustrated in FIG. 6, case 100 accommodates electrode assembly 200. Electrode assembly 200 is accommodated in case 100 so that its winding axis is parallel to the X direction.

Specifically, the one or more wound type electrode assemblies 200 are accommodated inside an insulation sheet 600 arranged in case 100, together with an electrolyte solution (electrolyte), which is not illustrated. Examples of the electrolyte solution (the non-aqueous electrolyte solution) that is usable include an electrolyte solution (a non-aqueous electrolyte solution) in which LiPF₆ is dissolved at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. A solid electrolyte may be used instead of the electrolyte solution.

Insulation sheet 600 can be composed of resin for example. More specifically, the material of insulation sheet 600 is, for example, polypropylene (PP), polyethylene terephthalate (PET), polyphenylene sulfide (PPS), polyimide (PI), or polyolefin (PO).

Insulation sheet 600 is not necessarily required to cover electrode assembly 200 entirely. Preferably, insulation sheet 600 covers about 50% or more, more preferably about 70% or more, of the outer surface area of the electrode assembly. Preferably, insulation sheet 600 entirely covers the four surfaces except the two surfaces of the six surfaces of electrode assembly 200 having a shape of a substantially rectangular parallelepiped (a flat shape), on which at least a later-described negative electrode tab group 220 and a later-described positive electrode tab group 250 are respectively formed.

Electrode assembly 200 includes a body portion (a portion in which a positive electrode plate and a negative electrode plate are stacked with a separator interposed therebetween), negative electrode tab group 220 (a first electrode tab group), and positive electrode tab group 250 (a second electrode tab group).

The body portion is constituted of the negative electrode plate and the positive electrode plate, which are described later. Negative electrode tab group 220 is positioned on an end portion of electrode assembly 200 on a first side in the first direction (the X direction) in relation to the body portion. The first side in the present embodiment corresponds to the first sealing plate 121 side. Positive electrode tab group 250 is positioned on an end portion of electrode assembly 200 on a second side in the first direction (the X direction) in relation to the body portion. The second side in the present embodiment corresponds to the second sealing plate 122 side.

Negative electrode tab group 220 and positive electrode tab group 250 are formed so as to project from a central portion of electrode assembly 200 toward first sealing plate 121 and second sealing plate 122, respectively.

Current collector 400 includes a negative electrode current collector 410 (a first current collector) and a positive electrode current collector 420 (a second current collector). Negative electrode current collector 410 and positive electrode current collector 420 are each composed of a plate-shaped member. Electrode assembly 200 is electrically connected to negative electrode terminal 131 and positive electrode terminal 132 via current collector 400.

Negative electrode current collector 410 is arranged on first sealing plate 121 with interposition of an insulation member made of resin. Negative electrode current collector 410 is electrically connected to negative electrode tab group 220 and negative electrode terminal 131. Negative electrode current collector 410 is composed of a conductive material (more specifically, metal) and can be composed of, for example, copper, a copper alloy, or the like.

Positive electrode current collector 420 is arranged on second sealing plate 122 with interposition of an insulation member made of resin. Positive electrode current collector 420 is electrically connected to positive electrode tab group 250 and positive electrode terminal 132. Positive electrode current collector 420 is composed of a conductive material (more specifically, metal) and can be composed of, for example, aluminum, an aluminum alloy, or the like. Positive electrode tab group 250 may be electrically connected to second sealing plate 122 directly or via positive electrode current collector 420. In this case, second sealing plate 122 may serve as positive electrode terminal 132.

Both negative electrode tab group 220 and positive electrode tab group 250 are accommodated in case 100 in a state of being folded in the shapes of curves.

### (Configuration of First Gas-Discharge Valve 151)

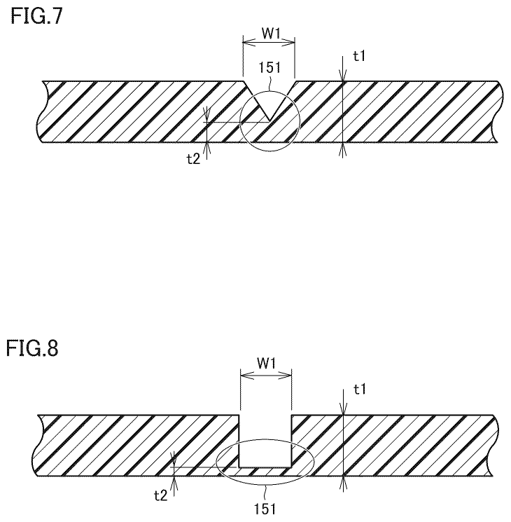

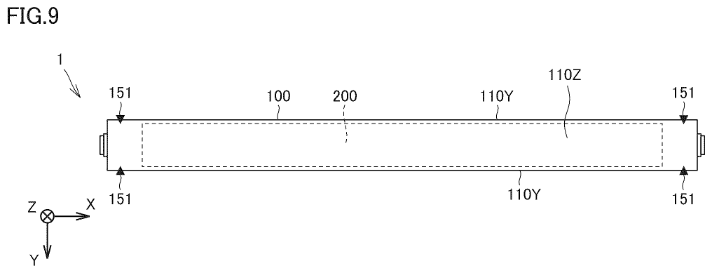

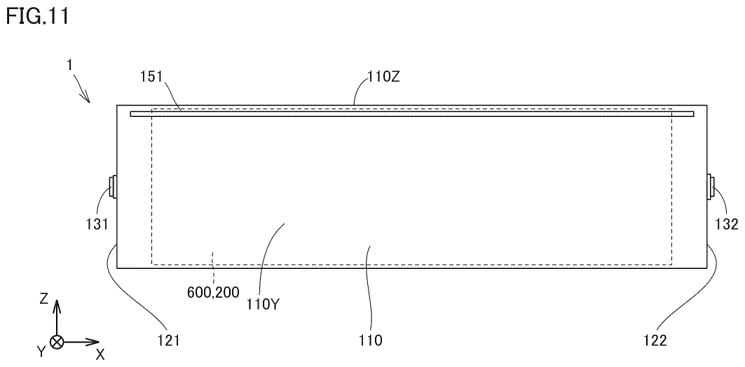

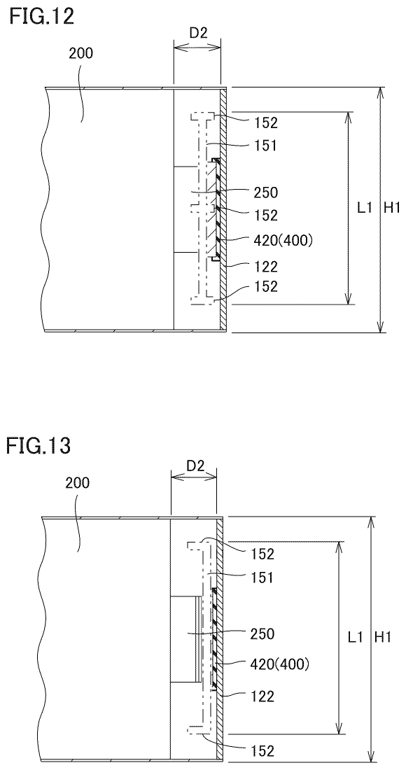

Referring to FIGS. 1, 2, and 6 to 13, the arrangement of first gas-discharge valve 151 in the present embodiment is described. FIG. 7 is a cross-sectional view illustrating a vulnerable portion (a thin portion) that constitutes the gas-discharge valve, FIG. 8 is a cross-sectional view illustrating the vulnerable portion (the thin portion) that constitutes the gas-discharge valve and has another configuration, FIGS. 9 to 11 are diagrams illustrating other arrangements of the gas-discharge valve, and FIGS. 12 and 13 are diagrams illustrating variations of the gas-discharge valve. The filled triangles in each drawing are used for convenience so as to indicate the positions in which first gas-discharge valve 151 is provided.

As illustrated in FIG. 1, in secondary battery 1 in the present embodiment, first gas-discharge valve 151 in the shape of a groove, which is constituted of the vulnerable portion, is provided in one of first side surface portions 110Y of case body 110 and situated in two positions: near the end portion on the first sealing plate 121 side and near the end portion on the second sealing plate 122 side. The vulnerable portion in the present embodiment is just required to have a function of rupturing prior to the remaining region when the pressure in case body 110 becomes equal to or exceeds a predetermined value and discharging the gas in case body 110 to the outside of case body 110.

First gas-discharge valve 151 is preferably provided both near the end portion on the first sealing plate 121 side and near the end portion on the second sealing plate 122 side. When first gas-discharge valve 151 on one side ruptures and a first opening is formed, the gas is discharged out of case 100 from the first opening. At this time, even if a component arranged in case 100, such as electrode assembly 200, blocks the first opening, first gas-discharge valve 151 on the other side ruptures subsequently and a second opening is formed. Thus, the gas can be discharged out of case 100 from the second opening. Accordingly, highly reliable secondary battery 1 is achieved.

As illustrated in FIG. 6, a length (L1) of first gas-discharge valve 151 in the Z direction (the height direction of secondary battery 1) is preferably ½ or more of a height (H1) of secondary battery 1, and is more preferably ⅔ or more of the height (H1) of secondary battery 1. A width (W1) of first gas-discharge valve 151 in the X direction (the width direction of secondary battery 1) is preferably 0.05 mm or more. The width (W1) of first gas-discharge valve 151 in the X direction is preferably 10 mm or less, is more preferably 5 mm or less, and is still more preferably 2 mm or less.

The width (W1) of first gas-discharge valve 151 in the X direction is preferably made ⅓ or less of a width (D1 in the drawings) between an end portion of a negative electrode active material layer of electrode assembly 200 and the inner surface of first sealing plate 121 or a width (D2 in the drawings) between an end portion of the negative electrode active material layer of electrode assembly 200 and the inner surface of second sealing plate 122.

In the present embodiment, while the winding axis of electrode assembly 200 extends in the X direction, first gas-discharge valve 151 has a linear shape extending in the Z direction orthogonal to the X direction.

As illustrated in FIG. 6, the region in which first gas-discharge valve 151 is formed is preferably provided in first side surface portion 110Y, which is on the larger area side of case body 110. Further, this region is preferably positioned so as not to face electrode assembly 200. Specifically, in the side surface on the larger area side of case body 110, first gas-discharge valve 151 is preferably provided, on the first sealing plate 121 side, in a region (corresponding to D1 in the drawings) between the end portion of the negative electrode active material layer of electrode assembly 200 and the inner surface of first sealing plate 121. It depends on the capacity of secondary battery 1 but first gas-discharge valve 151 is preferably provided in a region within about 3 cm from the inner surface of first sealing plate 121.

Similarly, on the second sealing plate 122 side, first gas-discharge valve 151 is preferably provided in a region (corresponding to D2 in the drawings) between the end portion of the negative electrode active material layer of electrode assembly 200 and the inner surface of second sealing plate 122. It depends on the capacity of secondary battery 1 but first gas-discharge valve 151 is preferably provided in a region within about 3 cm from the inner surface of second sealing plate 122.

As illustrated in FIG. 7, the cross section of first gas-discharge valve 151, which is formed so as to be depressed in the plate thickness direction of case body 110, may have a groove structure with a triangular shape. As illustrated in FIG. 8, the cross section of first gas-discharge valve 151, in which the thickness is made small in comparison with the remaining region, may have a groove structure with a rectangularly depressed shape. For example, in any groove structure, the remaining thickness (t2) is ⅓ or less of the plate thickness (t1) of case body 110 (t2≤(t1/3), preferably. A bottom part of the groove portion with a cross section that has a rectangularly depressed shape as depicted in FIG. 8 may be provided with a groove having a smaller width (e.g. a notch).

When first gas-discharge valve 151 is provided as described above, first gas-discharge valve 151 is positioned, in case 100, to face negative electrode tab group 220 and positive electrode tab group 250 accommodated in the state of being folded in the shapes of curves accordingly. Thus, first gas-discharge valve 151 functions easily and a highly reliable secondary battery is obtained.

In a plan view of first side surface portion 110Y, first gas-discharge valve 151 may partially overlap the body portion of electrode assembly 200, and for example, is preferably arranged so that, in the plan view, 50% or more, more preferably 70% or more, of the total area of first gas-discharge valve 151 does not overlap the body portion of electrode assembly 200.

By providing first gas-discharge valve 151 as described above, first gas-discharge valve 151 is enabled to rupture readily and exert a function as an explosion-proof valve easily. In particular, even if gas occurs near the end portion on the first sealing plate 121 side or near the end portion on the second sealing plate 122 side in electrode assembly 200, first gas-discharge valve 151 that is closer functions. Accordingly, a gas discharge path is shortened and gas discharge performance can be enhanced. Further, for example, when secondary batteries 1 are arranged side by side to be used as a battery assembly, direct blow (spreading burning) of the high-temperature gas discharged from first gas-discharge valve 151 against adjoining secondary batteries 1 can be inhibited by providing first gas-discharge valve 151 in the above-described regions. In addition, a disposal path inside secondary battery 1 can be prevented from getting clogged. The configuration of the battery assembly is described later.

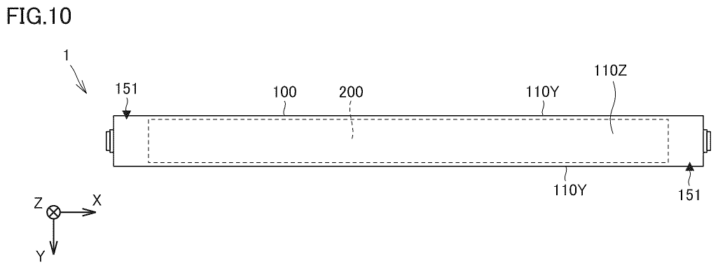

The positions in which first gas-discharge valve 151 is provided are not limited to the above-described configuration where first gas-discharge valve 151 is provided in two positions in one of first side surface portions 110Y. For example, as illustrated in FIG. 9, first gas-discharge valve 151 may be provided in both first side surface portions 110Y. For another example, as illustrated in FIG. 10, first gas-discharge valve 151 may be provided on one end side of one of first side surface portions 110Y while first gas-discharge valve 151 may be provided on the other end side of the other first side surface portion 110Y.

According to the description above, first gas-discharge valve 151 is positioned so as to extend in the Z direction near the end portion on the first sealing plate 121 side and/or near the end portion on the second sealing plate 122 side. However, as illustrated in FIG. 11, first gas-discharge valve 151 may be provided that extends in the X direction so as to include regions near the end portion on the first sealing plate 121 side and near the end portion on the second sealing plate 122 side. Both end portions of first gas-discharge valve 151 are not necessarily required to be positioned near the end portion on the first sealing plate 121 side and near the end portion on the second sealing plate 122 side. It is just required that one of the end portions of first gas-discharge valve 151 be positioned near the end portion on the side of one of the sealing plates. As illustrated in FIG. 11, when first gas-discharge valve 151 extends in the X direction, electrode assembly 200 is preferably a wound electrode assembly and the winding axis of electrode assembly 200 is preferably positioned so as to extend in the X direction. In this case, first gas-discharge valve 151 is preferably arranged in a position where first gas-discharge valve 151 faces a bent portion formed in an end portion of the wound electrode assembly.

The form of first gas-discharge valve 151 is not limited to the form in which it is constituted solely of the above-described linear portion (a first linear portion). As illustrated in FIG. 12, a second gas-discharge valve 152 as a second linear portion, which extends in the direction intersecting first gas-discharge valve 151 as the first linear portion, may be provided in both end portions and a central portion of first gas-discharge valve 151. As illustrated in FIG. 13, second gas-discharge valve 152 as the second linear portion, which extends in the direction intersecting first gas-discharge valve 151 as the first linear portion, may be provided so as to extend toward electrode assembly 200 from both end portions of first gas-discharge valve 151. The number of second gas-discharge valves 152 provided is not limited to the above-described number but can be selected as necessary.

By selecting the positions in which second gas-discharge valve 152 is provided, the cleavage area in the case of cleavage of first gas-discharge valve 151 and second gas-discharge valve 152 in thermal runaway can be increased. Further, the increase in cleavage area can enhance the gas discharge performance. Moreover, depending on the positions in which second gas-discharge valve 152 is provided, it is possible to control how first gas-discharge valve 151 and second gas-discharge valve 152 will be opened.

When first side surface portion 110Y is provided with first gas-discharge valve 151 and/or second gas-discharge valve 152, it is unnecessary to provide a gas-discharge valve in second side surface portion 110Z, first sealing plate 121, and second sealing plate 122 as remaining regions. Accordingly, space for providing the gas-discharge valve in the remaining regions is obviated, and higher energy and higher density can be achieved.

### (Battery Assembly 1000)

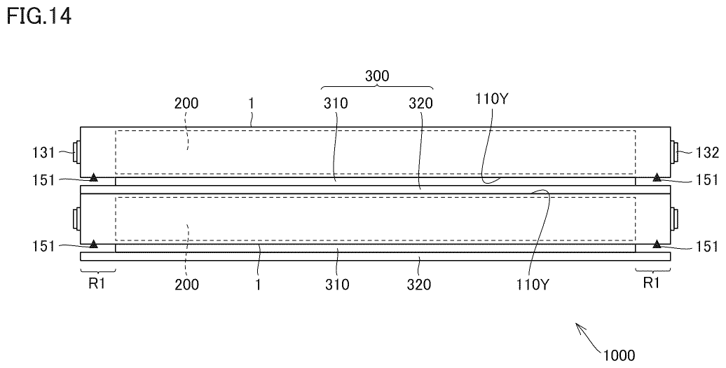

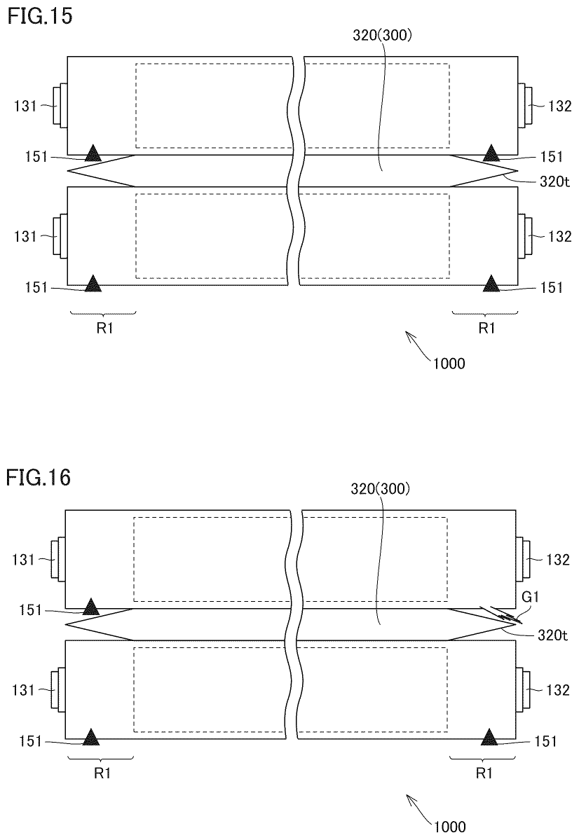

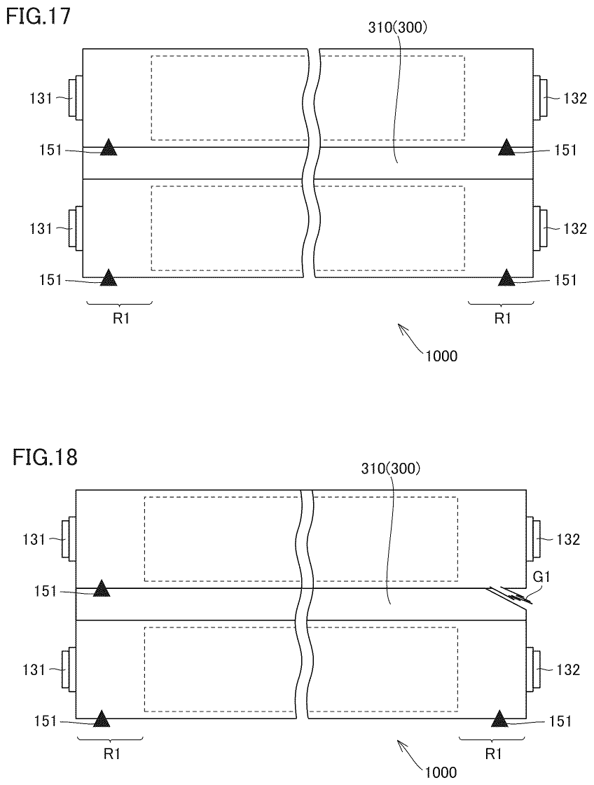

Referring to FIGS. 14 to 18, the configuration of battery assembly 1000 is described below, in which above-described secondary batteries 1 are arranged side by side. FIG. 14 is a schematic diagram illustrating the configuration of battery assembly 1000, FIG. 15 is a schematic diagram of battery assembly 1000 in which only an elastic layer is provided between the secondary batteries arranged side by side, FIG. 16 is a schematic diagram illustrating a cleavage state of first gas-discharge valve 151 at the time when gas is discharged in battery assembly 1000 depicted in FIG. 15, FIG. 17 is a schematic diagram of battery assembly 1000 in which only a heat-resistant layer is provided between the secondary batteries arranged side by side, and FIG. 18 is a schematic diagram illustrating a cleavage state of first gas-discharge valve 151 at the time when gas is discharged in battery assembly 1000 depicted in FIG. 17. Although each drawing illustrates battery assembly 1000 in which two secondary batteries 1 are arranged side by side, the number is not limited but the similar applies to a battery assembly in which two or more secondary batteries 1 are arranged side by side.

Referring to FIG. 14, in battery assembly 1000, two secondary batteries 1 are arranged side by side with inter-cell separator 300 interposed therebetween, and arranged side by side so that first side surface portions 110Y of both cases 100 face each other. Various forms are conceivable for battery assembly 1000, such as the form in which two secondary batteries 1 are stored in a frame body, the form in which secondary batteries 1 are stored in a frame body shaped like a box, the form in which a pair of end plates are used and the end plates are restrained with a binding bar, or the like.

Inter-cell separator 300 is preferably a resin plate, a rubber sheet, a heat insulator, or a laminate in which these are superposed. The laminate preferably has electrical insulation properties and heat-resistant properties. Inter-cell separator 300 depicted in FIG. 14 includes elastic layer 310 and heat-resistant layer 320.

For elastic layer 310, silicone rubber, fluororubber, urethane rubber, natural rubber, styrene-butadiene rubber, butyl rubber, ethylene propylene rubber (EPM, EPDM), butadiene rubber, isoprene rubber, norbornene rubber, or the like is employed. The thickness of elastic layer 310 is preferably, for example, 0.5 mm or more and 10 mm or less.

Since the elastic modulus of elastic layer 310 varies, depending on a pushing speed, history, a pushing range, and the like, the below-described definition of the elastic modulus is used. An FS curve (a pressurization speed 30 N/min.) is obtained using a square test piece having each side of 5 cm. The elastic modulus is calculated from the slope of a compression ratio of 1% to 20% when the horizontal axis indicates the compression ratio and the vertical axis indicates the pressure. The aforementioned value is preferably 1 Mpa or more and 10 Mpa or less.

For heat-resistant layer 320, a material smaller in elastic modulus than elastic layer 310 and superior in heat-resistant properties to elastic layer 310 is employed. For example, high-melting-point resin (resin higher in melting point than the resin that the elastic layer is composed of), a resin member containing ceramic particles, silica aerogel, a porous body that is mainly composed of silica, or the like is preferably employed. Preferably, heat-resistant layer 320 has higher heat insulation properties (lower thermal conductivity per unit volume) than elastic layer 310. The thickness of heat-resistant layer 320 is preferably, for example, 0.5 mm or more and 10 mm or less.

Inter-cell separator 300 is preferably arranged so as not to face first gas-discharge valve 151. It is unpreferable for first gas-discharge valve 151 to be completely blocked by inter-cell separator 300, and first gas-discharge valve 151 may partially be covered with inter-cell separator 300. As described later, even when first gas-discharge valve 151 is completely blocked by inter-cell separator 300, it may be tolerable in some cases.

In the configuration illustrated in FIG. 14, elastic layer 310 is arranged on first side surface portion 110Y where first gas-discharge valve 151 is provided, and arranged so as not to cover first gas-discharge valve 151. Heat-resistant layer 320 is arranged on first side surface portion 110Y where first gas-discharge valve 151 is not provided, and arranged so as to wholly cover first side surface portion 110Y. Heat-resistant layer 320 includes a region facing first gas-discharge valve 151. That is, the area of heat-resistant layer 320 is made larger than the area of elastic layer 310.

Thus, when inter-cell separator 300 is observed in the height direction along first side surface portion 110Y (the Z direction), the region of inter-cell separator 300 facing first gas-discharge valve 151 includes a region (a first region R1) having a thickness smaller than that of the region facing first gas-discharge valve 151. As a result, space corresponding to the thickness of elastic layer 310 is provided in the first region facing first gas-discharge valve 151.

Accordingly, first gas-discharge valve 151 is not in direct contact with first region R1, first gas-discharge valve 151 is not hindered from deforming or rupturing, the valve opening function of first gas-discharge valve 151 is enabled to appear easily, and the gas discharge performance can be enhanced. In addition, since elastic layer 310 wholly covers first side surface portion 110Y, direct hitting of gas on adjoining secondary battery 1 can also be prevented.

Since first region R1 provided in inter-cell separator 300 has a thickness smaller than that of the central portion of inter-cell separator 300 (the portion overlapping the body portion of electrode assembly 200), first region R1 is preferably situated near an outer peripheral edge portion of inter-cell separator 300. For example, in a view in the Y direction, the proportion of the area of the region overlapping first region R1 in the total area of first gas-discharge valve 151 is preferably 20% or more, is more preferably 30% or more, and is still more preferably 50% or more.

In the arrangement relation between first gas-discharge valve 151 and inter-cell separator 300, the facing area of heat-resistant layer 320 and first gas-discharge valve 151 is preferably larger than the facing area of elastic layer 310 and first gas-discharge valve 151. The facing area denotes the area of a region that constitutes first gas-discharge valve 151 and faces inter-cell separator 300. First gas-discharge valve 151 may be positioned so as to partially overlap inter-cell separator 300. For example, when observed in the direction orthogonal to first side surface portion 110Y (the Y direction), first gas-discharge valve 151 is preferably arranged in a position where first gas-discharge valve 151 does not overlap inter-cell separator 300 by 50% or more, more preferably 70% or more, of the total area of first gas-discharge valve 151.

Referring to FIGS. 15 to 18, other arrangement relations between first gas-discharge valve 151 and inter-cell separator 300 are described next. In inter-cell separator 300 depicted in FIGS. 15 and 16, only heat-resistant layer 320 is provided. In this configuration, first region R1 provided in both end portions of heat-resistant layer 320 includes a tapering portion 320t that tapers to a tip at a respective end.

Thus, even with heat-resistant layer 320 only, first gas-discharge valve 151 can be avoided from getting completely blocked in first region R1 by providing tapering portion 320t. In addition, as illustrated in FIG. 16, since gap is formed between heat-resistant layer 320 and first gas-discharge valve 151, the valve opening function of first gas-discharge valve 151 and the discharge performance of gas G1 are not impaired.

Moreover, in another arrangement relation of first gas-discharge valve 151 and inter-cell separator 300, which is illustrated in FIGS. 17 and 18, only elastic layer 310 is provided in inter-cell separator 300. In this configuration, first region R1 provided in both end portions of elastic layer 310 covers first gas-discharge valve 151.

However, even in the state where first gas-discharge valve 151 is covered with elastic layer 310, elastic layer 310 is deformable. Thus, when first gas-discharge valve 151 functions and gas G1 is discharged in first region R1, elastic layer 310 deforms. As a result, also with this configuration, the valve opening function of first gas-discharge valve 151 and the discharge performance of gas G1 are not impaired.

Although embodiments of the present invention have been described, it should be understood that the herein-disclosed embodiments are presented by way of illustration and example in every respect and are not to be taken by way of limitation. The scope of the present invention is defined by the claims and intended to include all changes within the purport and scope equivalent to the claims.

What is claimed is:

1. A secondary battery comprising:
an electrode assembly including a first electrode, and a second electrode having a polarity different from a polarity of the first electrode; and
a case accommodating the electrode assembly; wherein
the case includes
a case body having one end portion provided with a first opening and another end portion provided with a second opening,
a first sealing plate sealing the first opening, and
a second sealing plate sealing the second opening,
the case body includes
a pair of first wall portions facing each other, and
a pair of second wall portions facing each other,
an area of the first wall portion is larger than an area of the second wall portion, and
at least one of the first wall portions includes a thin portion that, when pressure in the case becomes equal to or exceeds a predetermined value, ruptures and causes gas in the case to be discharged out of the case.

2. The secondary battery according to claim 1, wherein the thin portion is provided both near an end portion of one of the first wall portions on a first sealing plate side and near an end portion of the other of the first wall portions on a second sealing plate side.

3. The secondary battery according to claim 1, wherein the thin portion is provided both near an end portion of one of the first wall portions on a first sealing plate side and near an end portion of the one of the first wall portions on a second sealing plate side.

4. The secondary battery according to claim 1, wherein the thin portion is formed in at least one of a region facing a portion between an end portion of a body portion of the electrode assembly on a first sealing plate side and the first sealing plate, and a region facing a portion between an end portion of the body portion of the electrode assembly on a second sealing plate side and the second sealing plate.

5. The secondary battery according to claim 1, wherein
the electrode assembly is a wound electrode assembly having a flat shape and includes a bent portion having a pair of bending outer surfaces, and
the thin portion is formed in a position where the thin portion faces the bent portion.

6. The secondary battery according to claim 1, wherein the thin portion includes a first linear portion, and a plurality of second linear portions intersecting the first linear portion.

7. A battery assembly comprising a plurality of secondary batteries, wherein
the secondary battery includes
an electrode assembly including a first electrode, and a second electrode having a polarity different from a polarity of the first electrode, and
a case accommodating the electrode assembly,
the case includes
a case body having one end portion provided with a first opening and another end portion provided with a second opening,
a first sealing plate sealing the first opening, and
a second sealing plate sealing the second opening,
the case body includes
a pair of first wall portions facing each other, and
a pair of second wall portions facing each other,
an area of the first wall portion is larger than an area of the second wall portion,
at least one of the first wall portions includes a thin portion that, when pressure in the case becomes equal to or exceeds a predetermined value, ruptures and causes gas in the case to be discharged out of the case, and
among the secondary batteries, an inter-cell separator is arranged between the first wall portions that adjoin each other and are arranged so as to face each other.

8. The battery assembly according to claim 7, wherein at least part of the thin portion is arranged in a position where the at least part of the thin portion does not overlap the inter-cell separator when viewed in a direction orthogonal to the first wall portion.

9. The battery assembly according to claim 7, wherein
the inter-cell separator includes a first region having a thickness smaller than a thickness of a remaining portion, and
at least part of the thin portion faces the first region.

10. The battery assembly according to claim 9, wherein the first region is a tapering portion.

11. The battery assembly according to claim 7, wherein
the inter-cell separator includes an elastic layer, and
at least part of the thin portion faces the elastic layer.

12. The battery assembly according to claim 7, wherein
the inter-cell separator includes an elastic layer and a heat-resistant layer, and
a facing area of the heat-resistant layer and the thin portion is larger than a facing area of the elastic layer and the thin portion.
